(19) United States
(12) Patent Application Publication
(10) Pub. No.: US 2012/0150421 A1
(43) Pub. Date: Jun. 14, 2012

(54) Dynamic Transitioning Between Intersection Controller Traffic Engines

(76) Inventors: Mark Simpson, Huntington Beach, CA (US); Peter W. Ragsdale, Carlsbad, CA (US)

(21) Appl. No.: 12/963,374

(22) Filed: Dec. 8, 2010

(51) Int. Cl. G08G 1/07

(52) U.S. Cl. 701/117

(57) ABSTRACT

A method of transitioning from one traffic engine to a second traffic engine on a single advanced traffic controller is provided. A user enters, or the controller is programmed to enter, a request to change from the first traffic engine to a second traffic engine. The first traffic engine transitions to the red rest state. Then the second traffic engine takes control of the traffic signals and enters the flash exit mode, thus completing the transition.

### TECHNICAL FIELD

This invention relates to an advanced traffic controller and, more specifically, to a device and method of switching between traffic engines on the same advanced traffic controller.

### BACKGROUND OF THE INVENTION

Population growth, urbanization, and increased automobile ownership have resulted in increased traffic congestion. Increased traffic congestion directly results in increased slower speeds and longer trip times, and indirectly results in lost time, lost business, and increased air pollution, among other things. This, along with the increases in information technology, has led to interest in intelligent transportation systems (“ITS”). Traffic management increasingly relies on ITS, which adds information and communications technology deployed in the field. This is done to minimize the effects of traffic congestion and improve safety, among other things.

One component of ITS applications is the Advanced Transportation Controller (“ATC”). The ATC is an advanced, ruggedized field communications and process controller that is configurable for a verity of traffic management applications. In general, ATC can provide communication, control, and data gathering between the ATC and central control computers, other controllers, and control units for other devices deployed in the field. The ATC can host many typical applications, including traffic signal, traffic surveillance, ramp meter, CCTV cameras, speed monitoring, lane control, HOV access control, and others.

FIG. 1 shows the components of a typical ATC including a front panel 10 that has various user interfaces. The user interfaces may be displays and input devices that allow the unit to display status information, such as LCD display 12, among other things, and that allow the user to input commands to the ATC using, for example, a keypad 15. The typical ATC also has an engine board 20. The engine board 20 performs all computational functions for the ATC. The engine board 20 includes a central processing unit (“CPU”), random access memory (“RAM”), and communications interfaces 25.

One of the typical ATC applications is traffic signal or traffic intersection control. In this application, the ATC engine is loaded with software used to control the traffic intersection signals. FIG. 2 shows a typical ATC system 220 for traffic signal 230 intersection control. In this application the ATC engine has a programming philosophy, or set of assumptions, that determines how they are configured. These assumptions are based on units of time or movements of vehicles. These are the two most dominant strategies to program a traffic controller, but others are possible. The set of assumptions define that data inputs required by the controller in order to operate the intersection 20. The traffic controller data inputs are then used to determine which traffic signal output or outputs will be energized at each moment in an intersection's cycle. The software that runs on the ATC engine is called a “traffic engine.”

In a traditional ATC, only one traffic engine is available on any given ATC controller. Moreover, if one wishes to use change programming philosophy in a single traffic controller, a second traffic engine would be necessary. Currently, when transitioning between traffic engines, the ATC engine must be shut down, reprogrammed, and restarted with the new firmware. This requires that signals controlling the intersection be sent into an ALL FLASH mode while the intersection controller is offline. This has the potential to disrupt traffic flow. Thus, there is a need to be able to change firmware without disrupting traffic flow, such as to run more than one traffic engine on the same ATC at the same time, and to transition between the available traffic engines without taking the controller offline. By having at least two traffic engines running on the ATC, programming philosophies can be switched without disrupting traffic operation. This results in improved public safety, elimination of having to use the ALL FLASH mode and improved reliability when loading new firmware.

### BRIEF SUMMARY OF THE INVENTION

In one aspect, the present invention provides a method of transitioning control of traffic signals between at least two traffic engines on a single advanced traffic controller. The method includes the steps of: entering a request to transition from a first traffic engine to a second traffic engine; determining if a flash entry data for the first traffic engine exists; confirming the traffic signals are in a red rest state; transitioning control of the traffic signals from the first traffic engine to the second traffic engine by entering the second traffic engine into a flash exit state.

The invention further provides a method wherein a user enters the request to transition from the first traffic engine to the second traffic engine and a method wherein the advanced traffic controller is programmed to enter the request to transition from the first traffic engine to the second traffic engine.

The invention also contemplates the red rest state including one or more traffic signals in the red state, the stop state, or the don't walk state.

In another aspect, the present invention provides a method of transitioning control of traffic signals between at least two traffic engines on a single advanced traffic controller. The method includes the steps of: entering a request to transition from a first traffic engine to a second traffic engine; determining if a flash entry data for the first traffic engine exists; the first traffic engine transitioning the traffic signals into a flash entry state; confirming the traffic signals are in a red rest state; transitioning control of the traffic signals from the first traffic engine to the second traffic engine by entering the second traffic engine into a flash exit state.

The invention further provides a method wherein a user enters the request to transition from the first traffic engine to the second traffic engine and a method wherein the advanced traffic controller is programmed to enter the request to transition from the first traffic engine to the second traffic engine.

### BRIEF DESCRIPTION OF THE DRAWINGS

FIG. 1 schematically depicts a typical ATC controller;

FIG. 2 schematically depicts a typical system installation;

FIG. 3 depicts the transition diagram for transitioning from one traffic engine to another;

FIG. 4A depicts the system in the normal operations;

FIG. 4B depicts the system once a engine change request and been initiated;

FIG. 4C depicts the system once the traffic engines have transitioned to the red rest state;

FIG. 4D depicts the system initializing the change of Traffic Engine running the Field I/O;

FIG. 4E depicts the system once the change of the Traffic Engine running the Field I/O is complete; and

FIG. 4F depicts the system once the engine change request has been completed.

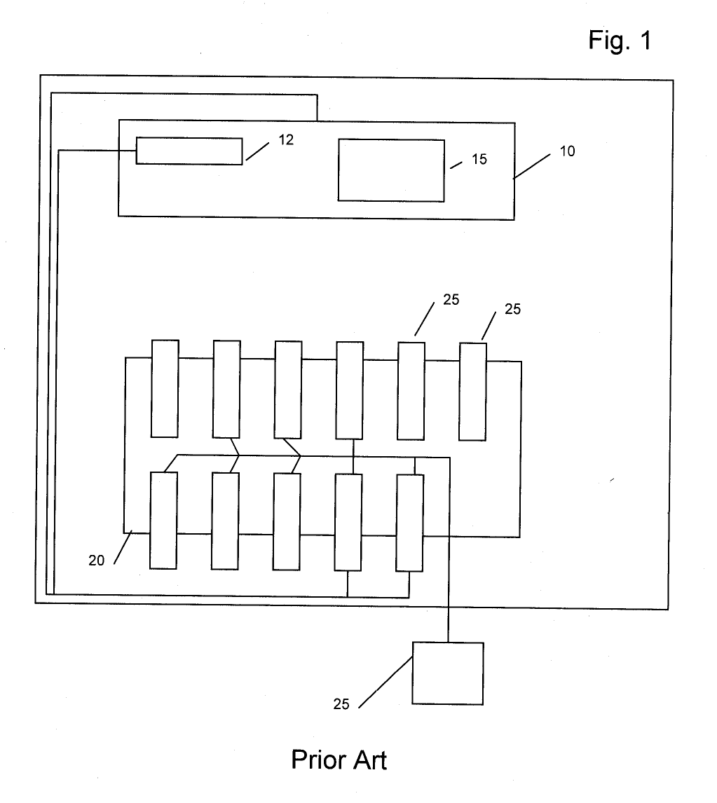

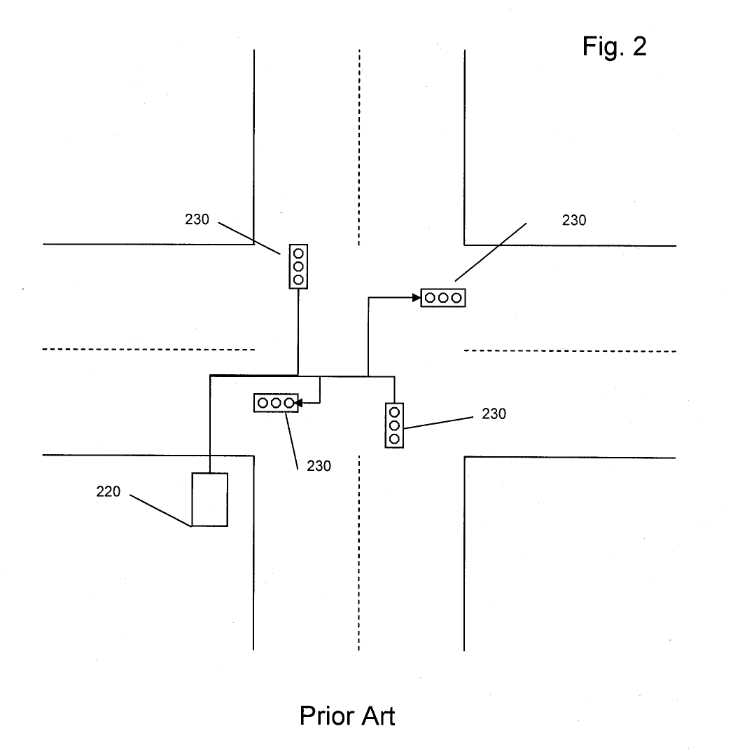

### DETAILED DESCRIPTION OF THE INVENTION

As used herein, “a” or “an” means one or more than one.

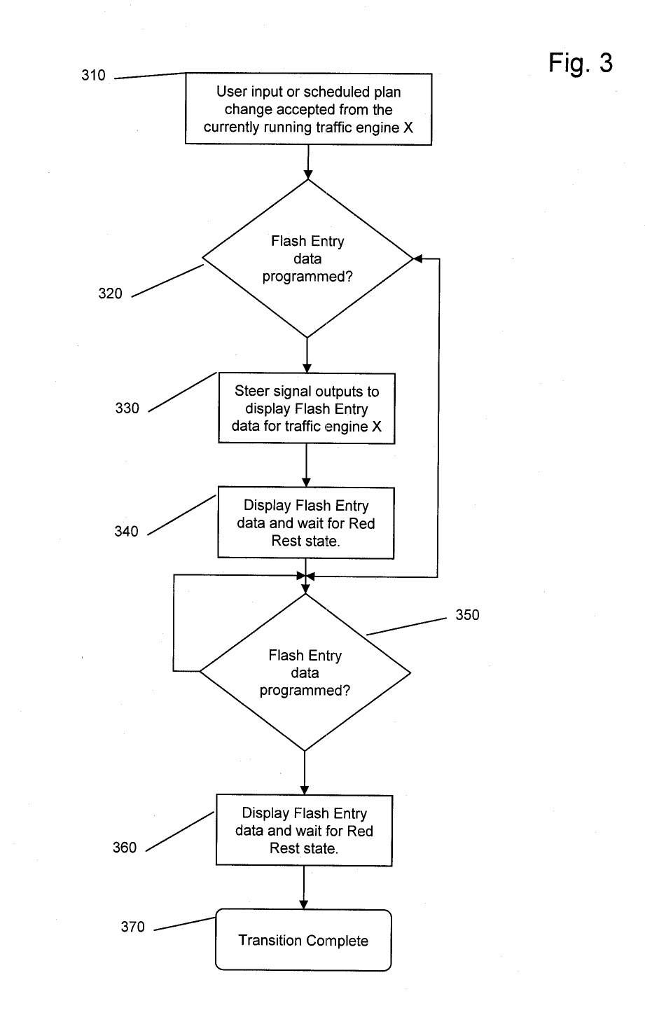

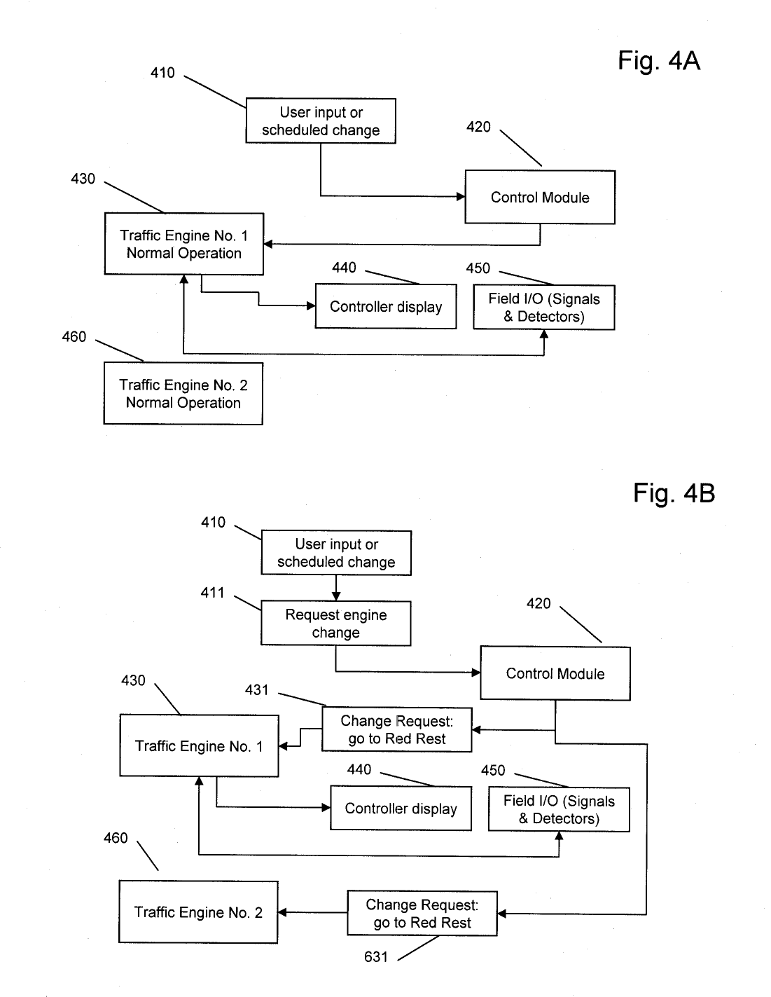

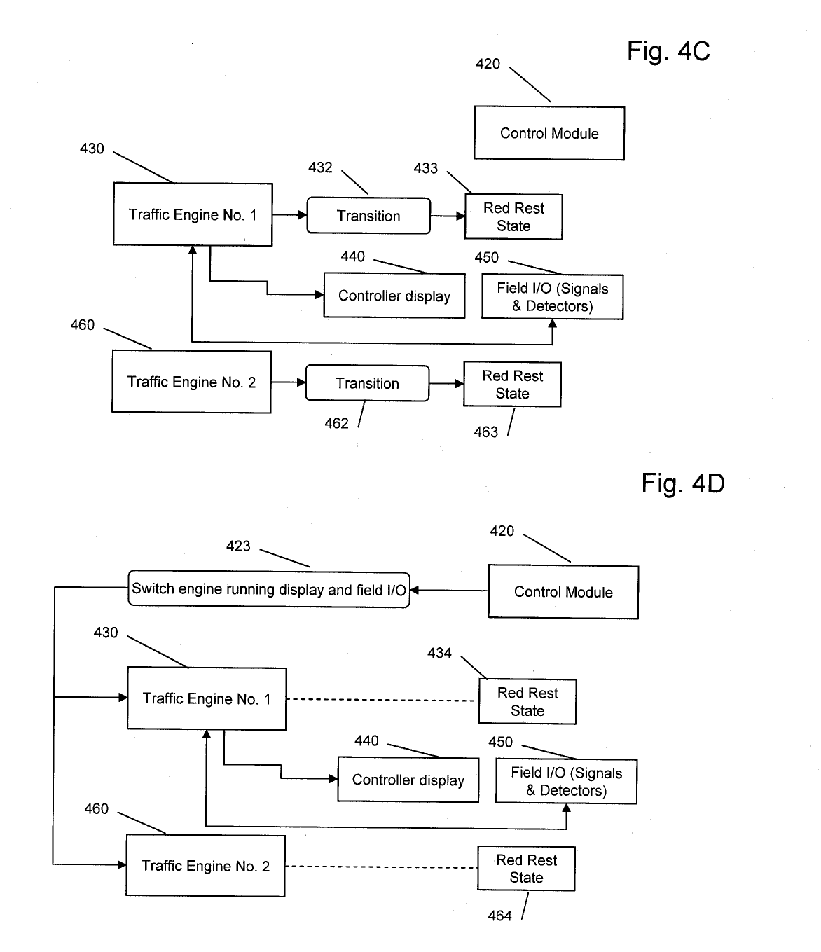

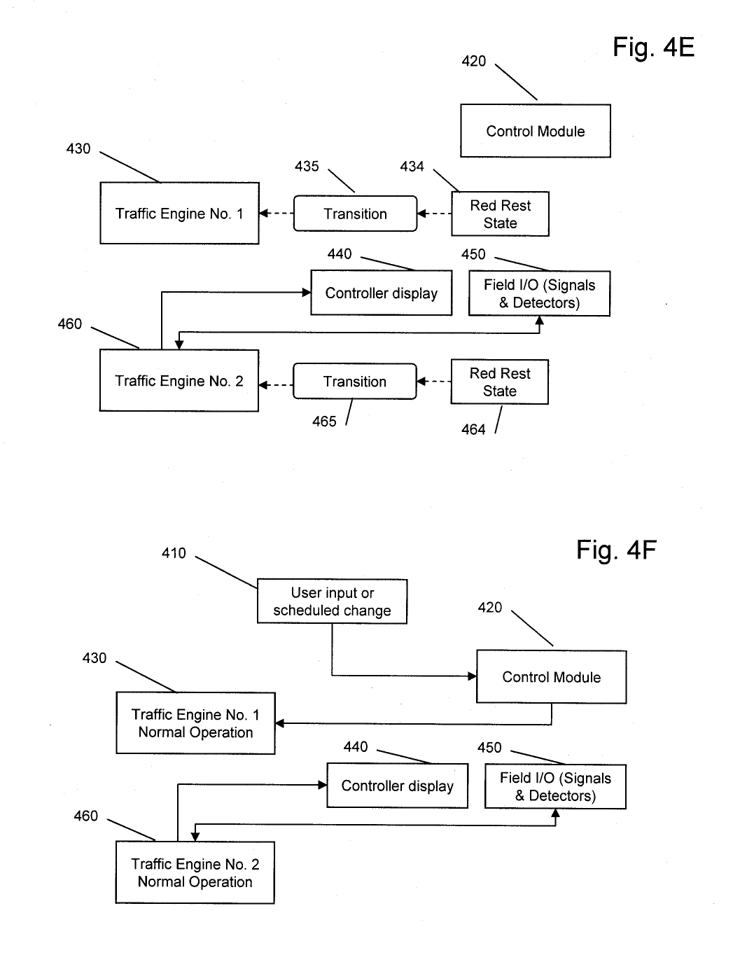

The methods and apparatus of the present invention will now be illustrated with reference to FIGS. 3 through 4F. It should be understood, that these are merely illustrative and not exhaustive examples of the scope of the present invention and that variations which are understood by those having ordinary skill in the art are within the scope of the present invention.

Turning now to FIG. 3, which shows generally the process by which the ATC switches from one traffic engine to another traffic engine. Beginning with step 310, the user, or the controller through a scheduled plan change, requests the change from the running traffic engine, X, to another traffic engine, Y. In the next step, 320, the controller determines whether a valid “Flash Entry” has been programmed. Flash Entry instructs the controller on how to time the transition from the running traffic engine to the “Programmed Flash” state. Programmed Flash instructs the controller to control the signals at an intersection in flash mode. That is, the lights on the side streets flash red as the lights on the main street simultaneously flash yellow. This is opposed to the traffic controller's normal state that repeatedly cycles the signals through red, green, yellow, and back to red. The values of the Flash Entry state control timing of the transition to the Programmed Flash state. The values depend on the timing required by the traffic flow, as well as the intersection's geometry. If valid Flash Entry is programmed, then the controller progresses to step 330. If a valid Flash Entry is not programmed, then the controller progresses to step 350. In step 330, the controller transitions to the Programmed Flash state. Next, the controller displays the Flash Entry data and waits for the “Red Rest” state, which is a state where all signals in the intersection are in the Red, Don't Walk, or STOP state. In step 350, the controller determines whether all signal outputs are set to red. If the signal outputs are set to red, then the controller starts the second traffic engine, Y, by staring the Flash Exit data. The Flash Exit data, like the Flash Entry data, instructs the control on how to time the transition from the Programmed Flash state to the running traffic engine.

FIGS. 4A-4E will now be used to discuss the preferred embodiment in further detail. FIG. 4A is a block diagram showing the initial controller state with the first traffic engine 430 as the running traffic engine. The second traffic engine 460, controller display 440, field I/O 450, control module 420, and user input 410 are also represented in FIG. 4A. As shown by the arrows, the first traffic engine 430, communicates with the control module 420, controller display 440, and field I/O 450. During this normal operation state, first traffic engine 430 steps field I/O 450 through the appropriate red, green, yellow states.

FIG. 4B depicts the state when a request to change traffic engines is received. When an engine change request 411 from a user, or a programmed change is received by user input 410, control module 420 sends the requests 431 and 461 to both the first traffic engine 430 and the second traffic engine 460. After the request is received by the traffic engines, the traffic engines then begin to transition to the Red Rest state. As discussed above, the controller may transition to the Programmed Flash state if the Flash Entry data is programmed. FIG. 4C depicts the transition to the Red Rest state. By utilizing this Red Rest output as an interim state, the intersection controller can be transitioned dynamically between the two traffic engines without the controller being stopped, and without requiring that the intersection go into Flash. The traffic engine that is currently controlling the intersection is transitioned to the Red Rest state using its normal transitioning methods. This transition works seamlessly, whether the intersection is running independently or in coordination with the rest of an arterial highway or even an adaptive city-wide network. At the point where the intersection signals are in Red Rest, the second Traffic Engine can then take over and transition the intersection out of the Red Rest state, using its own methods for smoothly transitioning to its normal operation. In this case, both the first traffic engine 430 and the second traffic engine 432 transitions to the red rest state 433 and 463. The status 421 of transition 432 and 463 is reported to control module 420. As shown by the arrows on both FIGS. 4B and 4C, the first traffic engine 430 controls the output to controller display 440 and communicates with field I/O 450.

Once the first traffic engine 430 and the second traffic engine 450 have reached their respective Red Rest states 434 and 464, as shown in FIG. 4D, then the control module sends a signal 423 to the traffic engines to switch the traffic engines controlling controller display 440 and field I/O 450. Once the traffic engine controlling the controller display 440 and field I/O 450 switches to the second traffic controller 460, as shown in FIG. 4E, then the traffic engines will transition from the red rest states in 435 and 465.

Once the transition is complete, as shown in FIG. 4F, the second traffic engine 460 is controlling the controller display 440 and communicating with the filed I/O 450. Control module 420 monitors user input 410 and communicates with second control engine 460.

Traffic controllers that comply with the Federal Highway Administration's Advanced Controller standard, version 5.2b, which is incorporated by reference as if fully set forth herein, are said to be “ATC Compliant.” The ATC standard defines the way that a traffic controller changes from one series of outputs in an intersection to another series as a “pattern change.” Every unique set of signal sequences programmed in the controller is called a pattern. Every unique set of signal sequences programmed in the controller is called a pattern. Using the invention disclosed herein, all available patterns are available to the user at all times.

For example, if a user requests the controller to transition to a new pattern, then the control module instruct the controller to transition from the running traffic engine to the second traffic engine using the steps discussed above. This minimized the time the traffic controller is in the Programmed Flash mode.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of transitioning control of traffic signals between at least two traffic engines on a single advanced traffic controller, the method comprising the steps of:
entering a request to transition from a first traffic engine to a second traffic engine;
determining if a flash entry data for the first traffic engine exists;
confirming the traffic signals are in a red rest state;
transitioning control of the traffic signals from the first traffic engine to the second traffic engine by entering the second traffic engine into a flash exit state.

2. The method of claim 1, wherein a user enters the request to transition from the first traffic engine to the second traffic engine.

3. The method of claim 1, where the advanced traffic controller is programmed to enter the request to transition from the first traffic engine to the second traffic engine.

4. The method of claim 1, wherein the red rest state comprises one or more traffic signals in the red state.

5. The method of claim 1, wherein the red rest state comprises one or more traffic signals in the stop state.

6. The method of claim 1, where in the red rest state comprises one or more traffic signals in the don't walk state.

7. A method of transitioning control of traffic signals between at least two traffic engines on a single advanced traffic controller, the method comprising the steps of:
entering a request to transition from a first traffic engine to a second traffic engine;
determining if a flash entry data for the first traffic engine exists;
the first traffic engine transitioning the traffic signals into a flash entry state;
confirming the traffic signals are in a red rest state;
transitioning control of the traffic signals from the first traffic engine to the second traffic engine by entering the second traffic engine into a flash exit state.

8. The method of claim 7, wherein a user enters the request to transition from the first traffic engine to the second traffic engine.

9. The method of claim 7, where the advanced traffic controller is programmed to enter the request to transition from the first traffic engine to the second traffic engine.

10. The method of claim 7 further comprising the step of the first traffic engine transitioning the traffic signals into a flash entry state.

11. The method of claim 7, wherein the red rest state comprises one or more traffic signals in the red state.

12. The method of claim 7, wherein the red rest state comprises one or more traffic signals in the stop state.

13. The method of claim 7, where in the red rest state comprises one or more traffic signals in the don't walk state.
